(19) United States
(12) Patent Application Publication
(10) Pub. No.: US 2003/0173343 A1
(43) Pub. Date: Sep. 18, 2003

(54) Method and installation for hybrid laser/arc welding using a power-diode laser

(76) Inventors: Olivier Matile, Paris (FR); Christian Bonnet, Puiseux Pontoise (FR)

Correspondence Address: Air Liquide, Intellectual Property Department, Suite 1800, 2700 Post Oak Boulevard, Houston, TX, 77056, US

(21) Appl. No.: 10/362,378

(22) PCT Filed: Aug. 2, 2001
(86) PCT No.: PCT/FR01/02523

(30) Foreign Application Priority Data
Aug. 21, 2000 (FR) 00/10753

(51) Int. Cl. B23K 26/20

(52) U.S. Cl. 219/121.64; 219/74; 219/137 R

(57) ABSTRACT

The invention concerns a method for welding one or several metal components to be assembled by producing at least one weld joint on said metal components to be welded, said weld joint being obtained by using a laser beam and at least an electric arc, which consists in generating said laser beam using a power-diode laser device. The invention also concerns an installation for implementing the welding method. The invention is useful for welding abutted flanks designed to constitute at least part of a motor vehicle body component.

The present invention relates to a hybrid welding process and a hybrid welding set that combine a laser beam with an electric arc, in particular a plasma arc, said laser beam being generated by a diode laser.

Among fusion joining processes, a distinction may be made between welding processes using:

an electric arc, such as MIG (Metal Inert Gas), MAG (Metal Active Gas) and TIG (Tungsten Inert Gas) processes, plasma processes, etc.;

an electron flux, such as electron-beam welding;

a photon flux, such as laser welding using a CO₂ or YAG laser beam.

Welding processes using an electric arc have the advantage of being inexpensive but they do result in limited productivity: low welding speed, not insignificant deformation of the workpieces to be joined together, especially in the case of small thicknesses, etc.

In contrast, processes using a photon flux, such as welding using what is called a “gas” laser (CO₂ laser) or a “solid-state” laser (Nd:YAG laser), themselves have appreciable advantages in terms of welding speed and work thicknesses, while limiting deformations.

However, the investment in laser sources of the CO₂ and YAG types is substantially greater than for arc welding sets.

In addition, the operating costs of gas or solid-state lasers are high, in terms of electrical efficiency and various consumables, such as the optics, the laser excitation system, etc.

Despite the abovementioned drawbacks, laser welding is tending to grow considerably in industry, essentially because of the performance in terms of productivity and low deformation of the workpieces that it is possible to achieve in laser welding.

With the purpose of further improving electric arc welding or laser welding processes, it was proposed several years ago to join metal workpieces together by using a hybrid welding technique that combines an electric arc with a laser beam, in particular a plasma arc and a laser beam.

Thus, various laser/arc hybrid welding processes have been disclosed, in particular in the documents EP-A-793 558; EP-A-782 489; EP-A-800 434; U.S. Pat. No. 5,006,688; U.S. Pat. No. 5,700,989; EP-A-844 042; Laser GTA Welding of aluminium alloy 5052 by T P Diebold and C E Albright, 1984, p. 18-24; SU-A-1 815 085, U.S. Pat. No. 4,689,466; Plasma arc augmented laser welding by R P Walduck and J. Biffin, p.172-176, 1994; or TIG or MIG arc augmented laser welding of thick mild steel plate, Joining and Materials by J Matsuda et al., p. 31-34, 1988.

At the present time, hybrid welding processes are, by dint of the performance characteristics that they make it possible to obtain, especially in terms of welding speed, being increasingly used in industrial sectors requiring the mass production of components, that is to say with high production yields, for example the automobile industry.

In general, a laser/plasma, or more generally laser/arc, welding process is a hybrid welding process which combines electric arc welding with a laser beam.

The laser/arc process consists in generating an electric arc between a consumable or non-consumable electrode and the workpiece to be welded, and in focussing a power laser beam into the arc region, that is to say near or in the mating face formed by the butting or the lapping of the workpieces to be welded together.

As indicated above, a hybrid process allows the welding speeds to be improved considerably compared with laser welding alone or arc or plasma welding alone, and furthermore makes it possible for the positioning tolerances on the edges before welding to be appreciably increased, and also the clearance tolerated between the edges to be welded, in particular compared with laser beam welding alone, which requires high precision in positioning the parts to be welded because of the small size of the focal spot of the laser beam.

The use of a plasma/laser process, and more generally a laser/arc process, requires the use of a welding head which makes it possible to combine, in a small space, the laser beam and its focusing device, together with a suitable welding electrode.

Several head configurations have been described in the abovementioned documents and it may be stated, in summary, that the laser beam and the electric arc or the plasma jet may be delivered by one and the same welding head, that is to say that they emanate via the same orifice, or else by two separate welding heads, one delivering the laser beam and the other the electric arc or plasma jet, these coming together in the welding zone.

Laser/arc hybrid processes are reputed to be perfectly suitable for the welding of tailored blanks for the automobile industry, and they make it possible to obtain a well wetted weld bead free of undercuts, as recalled in the documents EP-A-782 489 or Laser plus arc equals power, Industrial Laser Solutions, February 1999, p. 28-30.

In general, when producing the welded joint, it is essential to use an assist gas, in other words to assist the laser beam and protect the welding zone from external attack, and a gas for the electric arc, in particular a plasma gas used to create the arc plasma jet in the case of a plasma-arc process.

However, as explained above, if a laser welding set is already very expensive, it will be readily understood that a hybrid set combining a laser source with electric arc welding means is even more expensive, and then the resulting cost is often dissuasive for the user in view of the ensuing performance characteristics.

In other words, the high cost of hybrid sets is a considerable handicap in their industrial development, this being so despite the improved performance characteristics which can ensue compared with a conventional laser welding set or arc welding set.

Starting from these observations, the aim of the invention is therefore to provide a hybrid welding set and process whose cost is acceptable from the industrial standpoint without excessively restricting the performance characteristics compared with a conventional hybrid process combining an electric arc with a laser beam delivered by a laser source of the CO₂ type or of the Nd:YAG type.

The invention therefore relates to a process for the hybrid welding of one or more metal workpieces to be joined together by producing at least one welded joint on the said metal workpiece or workpieces to be welded, said welded joint being obtained by using at least one laser beam and at least one electric arc, in which process said laser beam is generated by means of a power-diode laser device.

Depending on the case, the process of the invention may include one or more of the following features:

the two longitudinal edges of a workpiece are welded together so as to obtain a welded tube or pipe;

two different metal workpieces are welded edge to edge;

the edge or end of a workpiece is welded to a surface of another workpiece, that is to say a lap welding operation is carried out;

the laser beam has a wavelength of between 0.808 and 0.940 μm.

the laser beam is conveyed right to the welding head via at least one optical fiber;

when welding the joint, at least one portion of the welding zone, including at least one portion of said welded joint being produced, is shielded with at least one shielding atmosphere formed by a gas mixture consisting of argon and/or helium, in an amount equal to or greater than 70% by volume, and of at least one additional compound chosen from H₂, O₂, CO₂, and N₂, in an amount of 0 to 30% by volume;

the workpiece or workpieces to be welded are made of a metal or a metal alloy chosen from coated or uncoated steels, particularly structural steels, carbon steels, steels having a zinc alloy coating on the surface, stainless steels, aluminum or aluminum alloys, and high yield strength steels;

the electric arc is a plasma arc;

the electrode is consumable or non-consumable;

the electric arc is delivered by a plasma-arc torch, both the laser beam and said arc being delivered by a single welding head;

the metal workpieces have different thicknesses, in particular the metal workpieces are tailored blanks;

the metal workpieces to be joined together, intended in particular for the manufacture of tailored blanks, have thicknesses and/or chemical compositions and/or metallurgical grades that are identical or different;

the workpieces to be welded are tailored blanks intended to constitute at least one portion of a vehicle body element;

the two edges to be welded are the two longitudinal edges of a tube or pipe, the welding being axial or helical welding.

The invention also relates to a welding set for welding one or more metal workpieces to be joined together by producing at least one welded joint on said metal workpiece or workpieces, said welded joint being obtained by using at least one laser beam and at least one electric arc, comprising at least one electrode for generating an electric arc and at least one laser device for generating a laser beam, characterized in that the laser device is of the power-diode type.

Preferably, the electrode and the laser head are incorporated in a single welding head delivering electric arc and laser beam via the same orifice.

Solid-state diode laser sources, usually called power diode lasers, are devices consisting of a stack of diodes coming from the semiconductor electronics industry.

Each element or diode emits a beam with a maximum power of 20 to 50 watts. The various beams output by the diode stack are treated optically and combined to give a rectangular focal spot of a few millimeters.

The energy densities achieved remain low compared with CO₂ and Nd:YAG lasers, but are nevertheless sufficient for conduction welding, that is to say welding in which the heat diffuses from the surface of the material.

In addition, the increase in power of the elementary components, that is to say the diodes, and the reduction in size of the focal spot make it possible to obtain a melting regime intermediate between thermal conduction and a capillary-type transfer mode, that is to say the creation of a capillary containing metal vapors and shielding gas at high temperature, thus transmitting the energy into the thickness of the material.

In general therefore, for the same electrical power, diode lasers have characteristics, in terms of welding speed and deformation of the workpieces, lying between arc welding processes and CO₂ and YAG laser welding processes.

Moreover, the fact that diode lasers are extremely compact and of limited weight allows them to be used directly on a robot or any other automated welding system.

Given the wavelength, generally between 0.808 and 0.940 μm, it is possible to transport the laser beam in an optical fiber.

Compared with CO₂ and Nd:YAG lasers, power diode lasers have an electrical efficiency of 40%, that is to say they are about four times more efficient.

For the same electrical power of about 2 kW, the investment in diode lasers is approximately equivalent to arc welding sources and therefore much less than the investment cost of CO₂ and YAG laser sources.

Consequently, by combining a high-power diode laser with a TIG, MIG, MAG or plasma, preferably plasma, arc welding source, it is possible to increase the productivity, especially the welding speed and the range of thicknesses that can be welded, while limiting any deformation, compared with just arc welding or laser welding processes.

However, such a combination is not to the detriment of the overall cost of the set since the use of a diode laser makes it possible to reduce the investment costs and the operating costs compared with hybrid sets using CO₂ or Nd:YAG lasers, while guaranteeing higher electrical efficiencies.

Furthermore, in terms of overall investment and running costs, the hybrid process of the invention lies approximately between arc welding processes and laser welding processes.

Depending on the possible geometries of welding heads, the hybrid processes according to the invention and the various means for conveying the gases or gas mixtures, the gas mixtures are those that are obtained in the area of interaction between the metal sheet(s) to be welded and the laser and the arc, independently of the manner in which it has been possible to create them.

1. A process for the welding of one or more metal workpieces to be joined together by producing at least one welded joint on the said metal workpiece or workpieces to be welded, said welded joint being obtained by using at least one laser beam and at least one electric arc, in which process said laser beam is generated by means of a power-diode laser device.

2. The welding process as claimed in claim 1, characterized in that the laser beam has a wavelength of between 0.808 and 0.940 μm.

3. The welding process as claimed in either of claims 1 and 2, characterized in that the laser beam is conveyed right to the welding head via at least one optical fiber.

4. The welding process as claimed in one of claims 1 to 3, characterized in that, when welding the joint, at least one portion of the welding zone, including at least one portion of said welded joint being produced, is shielded with at least one shielding atmosphere formed by a gas mixture consisting of argon and/or helium, in an amount equal to or greater than 70% by volume, and of at least one additional compound chosen from H₂, O₂, CO₂, and N₂, in an amount of 0 to 30% by volume.

5. The welding process as claimed in either of claims 1 and 2, characterized in that the workpiece or workpieces to be welded are made of a metal or a metal alloy chosen from coated or uncoated steels, particularly structural steels, carbon steels, steels having a zinc alloy coating on the surface, stainless steels, aluminum or aluminum alloys, and high yield strength steels.

6. The welding process as claimed in one of claims 1, 2 and 5, characterized in that the electric arc is a plasma arc.

7. The welding process as claimed in one of claims 1 to 6, characterized in that the electrode is consumable or non-consumable.

8. The welding process as claimed in one of claims 1 to 7, characterized in that the electric arc is delivered by a plasma-arc torch, both the laser beam and said arc being delivered by a single welding head.

9. The welding process as claimed in one of claims 1 to 8, characterized in that the metal workpieces have different thicknesses, in particular the metal workpieces are tailored blanks.

10. The welding process as claimed in one of claims 1 to 9, characterized in that the metal workpieces to be joined together, intended in particular for the manufacture of tailored blanks, have thicknesses and/or chemical compositions and/or metallurgical grades that are identical or different.

11. The welding process as claimed in one of claims 1 to 10, characterized in that the workpieces to be welded are tailored blanks intended to constitute at least one portion of a vehicle body element.

12. The welding process as claimed in one of claims 1 to 7, characterized in that the two edges to be welded are the two longitudinal edges of a tube or pipe, the welding being axial or helical welding.

13. A welding set for welding one or more metal workpieces to be joined together by producing at least one welded joint on said metal workpiece or workpieces, said welded joint being obtained by using at least one laser beam and at least one electric arc, comprising:
at least one electrode for generating an electric arc, and
at least one laser device for generating a laser beam,
characterized in that the laser device is of the power-diode type.

14. The set as claimed in claim 13, characterized in that the electrode and the laser head are incorporated in a single welding head delivering electric arc and laser beam via the same orifice.
